(19) United States
(12) Patent Application Publication
(10) Pub. No.: US 2022/0047016 A1
(43) Pub. Date: Feb. 17, 2022

(54) FACE MASK APPARATUS

(71) Applicant: KELLY SHAWN BELNAP, Dayton, OR (US)

(72) Inventor: KELLY SHAWN BELNAP, Dayton, OR (US)

(21) Appl. No.: 17/402,273

(22) Filed: Aug. 13, 2021

Related U.S. Application Data
(60) Provisional application No. 63/065,246, filed on Aug. 13, 2020.

(51) Int. Cl. A41D 13/11; A62B 18/08; A62B 18/02; A41D 31/14; G10L 21/003

(52) U.S. Cl. CPC A41D 13/1161; A62B 18/084; G10L 21/003; A41D 31/14; A62B 18/025

(57) ABSTRACT

Disclosed herein is a face mask apparatus, in accordance with some embodiments. Accordingly, the face mask apparatus may include a mask body and at least one first magnetic element. Further, the at least one first magnetic element may be disposed in at least one body portion of the mask body. Further, the at least one first magnetic element may be magnetically couplable with at least one second magnetic element disposed in at least one device portion of at least one attachment device. Further, the at least one first magnetic element magnetically attaches to the at least one second magnetic element for attaching the at least one body portion to the at least one device portion. Further, the at least one attachment device may be worn on at least a part of a head of a user.

### FIELD OF THE INVENTION

Generally, the present disclosure relates to the field of medical and laboratory equipment. More specifically, the present disclosure relates to a face mask apparatus.

### BACKGROUND OF THE INVENTION

There is good evidence that wearing face masks limits the spread of respiratory viral infections between human beings who interact within close proximity. A wide variety of face masks that utilize various materials and shapes are available in the current market. However, methods of fastening these face masks on a user's face mostly involve elastic bands that go behind the ears of the user or strings for tying the mask at the back of the user's head. These fastening methods are considered quite inconvenient and difficult for people with long hair, long beard, people wearing glasses, active kids, etc. Often times the elastic straps/strings come in between the hair of the user and there is an increased chance of the straps pinching/pulling on the user's skin/hair and/or the long straps getting untied during unfavorable situations. Thus, a face mask that may be attached to the user's face in a quick and easy fashion without the use of complicated strings is a rare find in the current market.

Therefore, there is a need for an improved face mask apparatus that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a face mask apparatus, in accordance with some embodiments. Accordingly, the face mask apparatus may include a mask body and at least one first magnetic element. Further, the at least one first magnetic element may be disposed in at least one body portion of the mask body. Further, the at least one first magnetic element may be magnetically couplable with at least one second magnetic element disposed in at least one device portion of at least one attachment device. Further, the at least one first magnetic element magnetically attaches to the at least one second magnetic element for attaching the at least one body portion to the at least one device portion. Further, the at least one attachment device may be worn on at least a part of a head of a user.

Further disclosed herein is a face mask apparatus, in accordance with some embodiments. Accordingly, the face mask apparatus may include a mask body and at least one first magnetic element. Further, the at least one first magnetic element may be disposed in at least one body portion of the mask body. Further, the at least one first magnetic element may be magnetically couplable with at least one second magnetic element disposed in at least one device portion of at least one attachment device. Further, the at least one first magnetic element magnetically attaches to the at least one second magnetic element for attaching the at least one body portion to the at least one device portion. Further, the at least one attachment device may be worn on at least a part of a head of a user. Further, the at least one first magnetic element and the at least one second magnetic element may be magnetically and detachably couplable. Further, the at least one first magnetic element magnetically and detachably attaches to the at least one second magnetic element for detachably attaching the at least one body portion to the at least one device portion.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of a face mask apparatus, in accordance with some embodiments.

FIG. 2 is a side perspective view of the face mask apparatus with the at least one side strip, in accordance with some embodiments.

FIG. 3 is a rear perspective view of the face mask apparatus with the at least one side strip, in accordance with some embodiments.

FIG. 4 is a side view of the face mask apparatus with the at least one side strip, in accordance with some embodiments.

FIG. 5 is a front view of the face mask apparatus with the at least one side strip, in accordance with some embodiments.

FIG. 6 is a front view of the face mask apparatus with the at least one side strip, in accordance with some embodiments.

FIG. 7 is a disassembled view of the face mask apparatus with the at least one side strip, in accordance with some embodiments.

FIG. 8 is a top perspective view of the at least one attachment device, in accordance with some embodiments.

FIG. 9 is a rear perspective view of the at least one attachment device, in accordance with some embodiments.

FIG. 10 is an enlarged view of a region A of FIG. 9, in accordance with some embodiments.

FIG. 11 is a perspective view of an attachment device of a face mask apparatus, in accordance with some embodiments.

FIG. 12 is a partial perspective view of an attachment device of the face mask apparatus, in accordance with some embodiments.

FIG. 13 is a front view of a mask body of the face mask apparatus, in accordance with some embodiments.

FIG. 14 is a front view of a side strip of the face mask apparatus, in accordance with some embodiments.

FIG. 15 is a front view of a mask body of a face mask apparatus, in accordance with some embodiments.

FIG. 16 is a front view of a mask body of a face mask apparatus, in accordance with some embodiments.

FIG. 17 is a front view of a side strip of the face mask apparatus, in accordance with some embodiments.

FIG. 18 is a front view of a metal clip of the face mask apparatus, in accordance with some embodiments.

FIG. 19 is a side view of the metal clip of the face mask apparatus, in accordance with some embodiments.

FIG. 20 is a top view of an attachment device of the face mask apparatus, in accordance with some embodiments.

FIG. 21 is a top perspective view of an attachment device of the face mask apparatus, in accordance with some embodiments.

FIG. 22 is a top perspective view of an attachment device of the face mask apparatus, in accordance with some embodiments.

FIG. 23 is a front view of a face mask apparatus, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a face mask apparatus, embodiments of the present disclosure are not limited to use only in this context.

Overview:

The present disclosure describes a face mask apparatus. Further, the face mask apparatus provides users with a face mask that may be attached to the user's face in a fast and effortless motion. In order to accomplish that, the face mask apparatus comprises a face mask with magnets disposed along the seams of the face mask. Further, the face mask apparatus aims to provide users a plurality of options with which the magnetic face mask may be adhered to the face, based on the preferences of the user. Accordingly, the present disclosure describes multiple ways, locations, and means with which magnetized and magnetic substances may be interacted between attachment means, such that the face mask may adhere to the user's face easily and conveniently. Thus, the face mask is an efficient, convenient, and aesthetically appealing face mask, which may be easily snapped on and may be used by children and adults of all ages.

Further, the present disclosure describes a magnetic face mask. An objective of the magnetic face mask is to provide users with a face mask that may be attached to the user's face in a fast and effortless motion. In order to accomplish that, the magnetic face mask comprises a face mask with magnets disposed along the seams of the face mask. It is an aim of the magnetic face mask to provide users a plurality of options with which the magnetic face mask may be adhered to the face, based on the preferences of the user. Accordingly, the present disclosure describes multiple ways, locations, and means with which magnetized and magnetic substances may be interacted between attachment means, such that the face mask may adhere to the user's face easily and conveniently.

Further, the magnetic face mask comprises a mask body, a plurality of magnets, a plurality of side strips, a plurality of magnetic substances (substances that are attracted to magnets), and at least one head attachment piece. Further, the mask body is a flexible and objectively designed piece of fabric that is capable of covering the nose and mouth area of a human face. Preferably, the mask body comprises a breathable, durable, and reusable fabric that has a plurality of tracks that may be formed all around the edges of the mask body, by folding and hemming the edges of the mask body. Further, it is preferred that the plurality of tracks is at least half-inch in width. Alternately, the mask body may comprise two layers of fabric sewn together in such a way that, a plurality of half inch wide tracks is formed along the seams of the mask body. However, the mask body may comprise any other shape, size, orientation, color, components, and arrangement of components that are known to one of ordinary skill in the art, as long as the intended purpose of the magnetic face mask is not altered. Examples of such face masks include, but are not limited to pleated masks, netted masks, masks that extend around the neck of the user, etc. Preferably, the plurality of tracks comprises a first track, a second track, a third track, and a fourth track. Further, the first track and the second track are positioned along an upper seam of the mask body, or along the hem that will be proximate to the nose region of the user. Further, the third track and the fourth track are positioned along a lower seam of the mask body. Furthermore, the plurality of tracks extends between a central axis of the mask body and four lateral ends of the mask body. Further, the plurality of magnets is disposed within the plurality of tracks. Preferably, the plurality of magnets is small round button magnets, such as neodymium discs that have ⅛th to ¼ inch radii, and that which would fit within the dimensions of the plurality of tracks. However, the plurality of magnets may comprise any other shape, size, brand, or composition. According to the preferred embodiment, a single magnet is placed within each of the plurality of tracks. Further, the plurality of magnets will be arranged/oriented in such a way that, in the presence of a magnetic material near the lateral ends of the upper seam, the magnets in the first track and the second track experience magnetic attraction or an electromagnetic pull between the magnets in the first track and the second track, and the external magnetic material. This leads to traversing of the magnets in the first track and the second track from the central axis region towards the magnetic materials at the lateral ends of the upper seam. The electromagnetic attraction between the magnets in the first track and second track, and the external magnetic materials will further make the magnets in the third track and the fourth track move towards the respective lateral ends. This phenomenon or electromagnetic attraction helps the lower seam of the mask body to stay unfolded or spread across the face of the user. Further, the broken lines within the plurality of tracks depict the direction of motion of the plurality of magnets.

Further, the plurality of side strips are removably attached to the mask body, and the side strips extend from the edges of the upper seam in a direction away from the third track and the fourth track, or in an upward direction. The plurality of side strips forms the connecting link between the mask body and the attachment means on the user's head. Preferably, the plurality of side strips is rectangular strips of a fabric that are sewn together leaving one or more pockets inside the side strips. According to the preferred embodiment, the plurality of side strips may comprise any material, shape, size, orientation, components, or arrangement of components. Further, the side strips house the magnetic materials that enable the magnetic fastening between the magnets along the edges of the face mask. Preferably, the magnetic materials within the side strips are two metal rings or washers arranged adjacent to each other.

In an alternate embodiment, the side strips may be permanently attached at the edges of the mask body.

Further, the present disclosure describes at least one head attachment piece. Further, the present disclosure describes a plurality of ways in which the magnetic face mask may be adhered to the user's face using the at least head attachment piece. Accordingly, one of the preferred ways of attaching the face mask to the user's head is with the help of magnets attached to the legs of glasses/spectacles. Further, small button magnets are attached to opposing sides on the legs of a glass frame, that go behind the ears of the user. Preferably, the plurality of magnets is attached to the legs of the glass frame by the process of heat shrinking. This process further ensures that there are no sharp edges around the magnets, thereby preventing any tugging or pulling of the user's skin or hair with the attached magnets. However, the magnets may be attached using any other fastening method.

Further, the present disclosure describes a preferred method of operation of the magnetic face mask. Further, the user may simply attach the face mask using the following steps. Firstly, wear on the glasses having magnets attached to the frame legs. Snap the plurality of side strips to the glasses by bringing the magnetic material in the side strips in close contact with the magnets on the frame legs. Following that, snap the mask body to lower hanging portions of the side strips, by simply bringing the mask close to the side strips.

For those who do not use glasses, an alternate head attachment piece may be a fabric headband, a cap, or even metal hairpins or hair clips. In such cases, magnets may be sewn into the fabric headbands in a concealed fashion. Further, magnets may be attached to two ends of a cap, and in such cases, instead of wearing the glasses, the user may put on the headband/hair hand or cap with built-in magnets before snapping the mask onto the face.

In an alternate embodiment, the side strips may comprise magnets within them. In such cases, a regular headband with an external metal clip or metal pin may be used to attach the magnetic face mask to the user's face. Preferably, the metal clips used are heat shrink-wrapped to provide a smooth interacting surface for the user's head/hair. However, metal clips of any size, shape, orientation, materials, components, or arrangement of components may be used as part of, or as the entire head attachment piece.

In an alternate embodiment, users with long beards and/or hair may use simple bobby pins/hairpins on their beards or hair to provide a magnetic surface and the magnetic face mask could snap onto the user's face in a second. Thus, the magnetic face mask is an efficient, convenient, and cost-efficient face mask that may be easily snapped on and may be used by children and adults of all ages.

Further, the present disclosure relates generally to face masks. More specifically, the present disclosure describes a face mask that may be attached to a user's face using various means that include magnets and magnetic fasteners.

Further, the present disclosure describes a face mask with magnetic connection means.

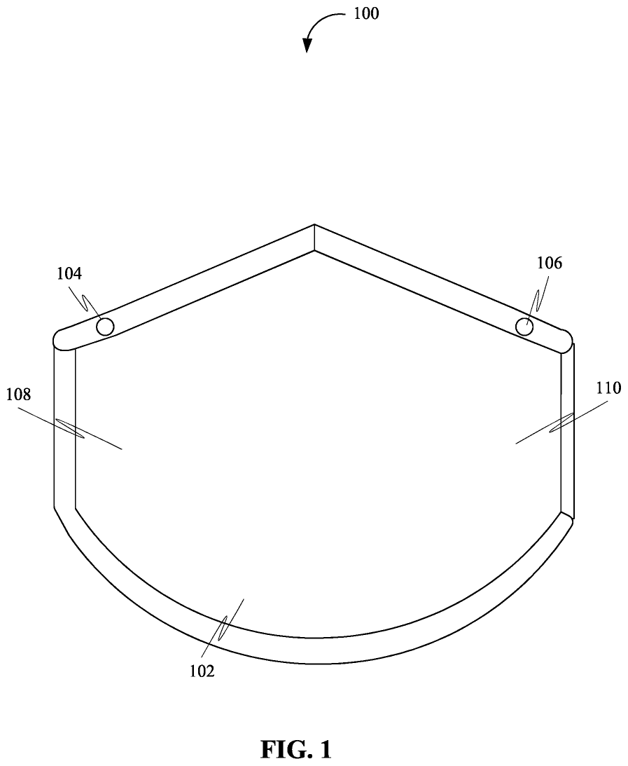

FIG. 1 is a front view of a face mask apparatus 100, in accordance with some embodiments. Accordingly, the face mask apparatus 100 may include a mask body 102 and at least one first magnetic element 104-106.

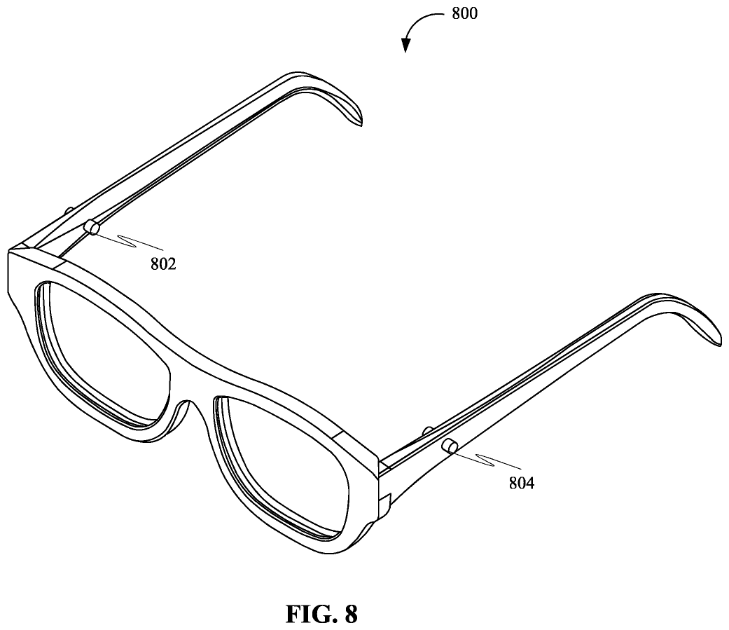

Further, the at least one first magnetic element 104-106 may be disposed in at least one body portion 108-110 of the mask body 102. Further, the at least one first magnetic element 104-106 may be comprised of a ferromagnetic material, a magnet, etc. Further, the at least one first magnetic element 104-106 may include a metal clip, a button magnet, a washer, etc. Further, the at least one first magnetic element 104-106 may be magnetically couplable with at least one second magnetic element 802-804 disposed in at least one device portion of at least one attachment device 800, as shown in FIG. 8. Further, the at least one second magnetic element 802-804 may be comprised of a ferromagnetic material, a magnet, etc. Further, the at least one second magnetic element 802-804 may include a metal clip, a button magnet, a washer, etc. Further, the at least one attachment device 800 may include a spectacle, a eyeglass, a sunglass, a headband, a hat, a cap, etc. Further, the at least one first magnetic element 104-106 magnetically attaches to the at least one second magnetic element 802-804 for attaching the at least one body portion 108-110 to the at least one device portion. Further, the at least one attachment device 800 may be worn on at least a part of a head of a user.

Further, in some embodiments, the at least one first magnetic element 104-106 and the at least one second magnetic element 802-804 may be magnetically and detachably couplable. Further, the at least one first magnetic element 104-106 magnetically and detachably attaches to the at least one second magnetic element 802-804 for detachably attaching the at least one body portion 108-110 to the at least one device portion. Further, in an embodiment, the mask body 102 may be configured for receiving at least one mask removing action on the mask body 102. Further, the at least one first magnetic element 104-106 detaches from the at least one second magnetic element 802-804 for detaching the at least one body portion 108-110 from the at least one device portion based on the receiving of the at least one mask removing action.

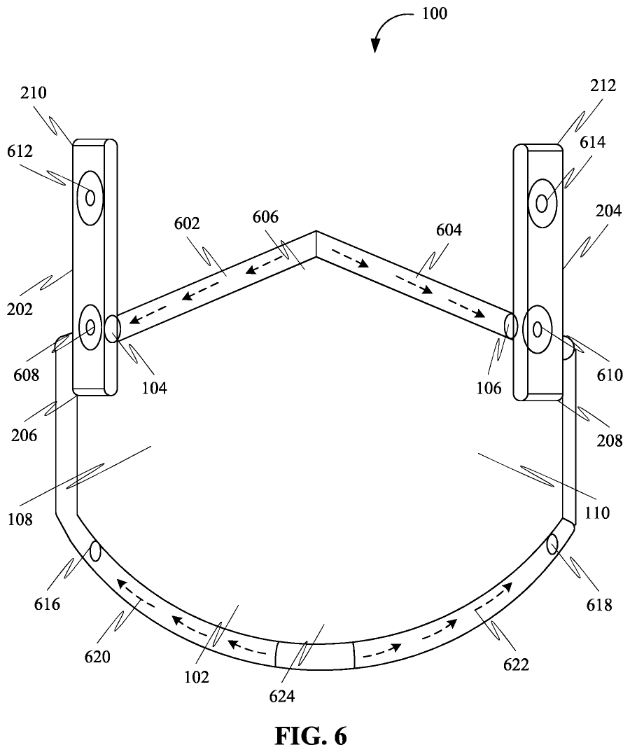

Further, in some embodiments, the mask body 102 may include at least one upper track 602-604, as shown in FIG. 6, disposed on at least one upper edge body portion 606 of the at least one body portion 108-110. Further, the at least one first magnetic element 104-106 may include at least one first upper magnetic element 104-106. Further, the at least one first upper magnetic element 104-106 and the at least one second magnetic element 802-804 may be magnetically couplable. Further, the at least one first upper magnetic element 104-106 may be movably disposed in the at least one upper track 602-604. Further, the at least one second magnetic element 802-804 may be fixedly disposed in the at least one device portion. Further, the at least one first upper magnetic element 104-106 may be configured for moving to at least one upper location in the at least one upper track 602-604 based on a placement of the mask body 102 proximal to the at least one attachment device 800. Further, the at least one first upper magnetic element 104-106 magnetically attaches to the at least one second magnetic element 802-804 in the at least one upper location for the attaching of the at least one edge body portion to the at least one device portion based on the moving. Further, in an embodiment, the mask body 102 may include at least one lower track 620-622 disposed on at least one lower edge body portion 624 of the at least one body portion 108-110. Further, the at least one first magnetic element 104-106 may include at least one first lower magnetic element 616-618. Further, the at least one first lower magnetic element 616-618 and the at least one first upper magnetic element 104-106 may be magnetically coupled. Further, the at least one first lower magnetic element 616-618 may be movably disposed in the at least one lower track 620-622. Further, the at least one first lower magnetic element 616-618 may be configured for moving to at least one lower location in the at least one lower track 620-622 based on the moving of the at least one first upper magnetic element 104-106 to the at least one upper location in the at least one upper track 602-604. Further, the moving of the at least one first lower magnetic element 616-618 to the at least one lower location prevents folding of at least a body portion of the mask body 102.

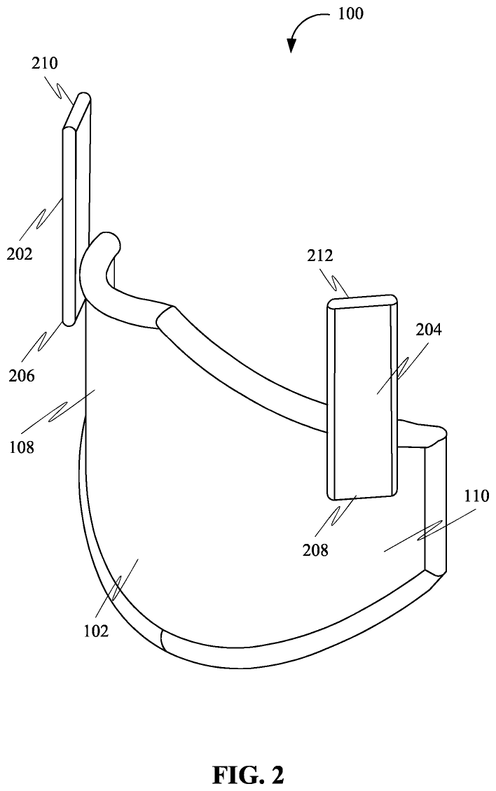

In further embodiments, at least one side strip 202-204, as shown in FIG. 2, may be configured for connecting the at least one attachment device 800 and the mask body 102. Further, the at least one side strip 202-204 extends between a first end (206 and 208) and a second end. Further, the at least one first magnetic element 104-106 may include at least one first strip magnetic element (608 and 610) and at least one second strip magnetic element (612 and 614). Further, the at least one first strip magnetic element (608 and 610) may be comprised in the first end (206 and 208) and the at least one second strip magnetic element (612 and 614) may be comprised in the second end (210 and 212). Further, the at least one first strip magnetic element (608 and 610) and the at least one first magnetic element 104-106 may be magnetically couplable and the at least one second strip magnetic element (612 and 614) and the at least one second magnetic element 802-804 may be magnetically couplable. Further, the at least one first strip magnetic element (608 and 610) magnetically attaches to the at least one first magnetic element 104-106 for attaching the first end (206 and 208) with the at least one body portion 108-110 and the at least one second strip magnetic element (612 and 614) magnetically attaches to the at least one second magnetic element 802-804 for attaching the second end (210 and 212) to the at least one device portion. Further, the connecting may be based on the attaching of the first end (206 and 208) with the at least one body portion 108-110 and the attaching of the second end (210 and 212) to the at least one device portion.

In further embodiments, at least one side strip 202-204, as shown in FIG. 2, may be configured for connecting the at least one attachment device 800 and the mask body 102. Further, the at least one side strip 202-204 extends between a first end (206 and 208) and a second end (210 and 212). Further, the first end (206 and 208) may be attached to the at least one body portion 108-110. Further, the at least one first magnetic element 104-106 may include at least one strip magnetic element. Further, the at least one strip magnetic element may be comprised in the second end (210 and 212). Further, the at least one strip magnetic element and the at least one second magnetic element 802-804 may be magnetically couplable. Further, the at least one strip magnetic element magnetically attaches with the at least one second magnetic element 802-804 for attaching the second end (210 and 212) to the at least one device portion. Further, the connecting may be based on the attaching of the second end (210 and 212) to the at least one device portion.

In further embodiments, a voice modulator may be comprised in a mouth portion of the mask body 102. Further, the voice modulator modulates a voice of the user.

Further, in some embodiments, the mask body 102 may be comprised of at least one fabric. Further, the at least one fabric may be breathable. Further, in an embodiment, the at least one fabric may be comprised of at least one material. Further, the at least one material may include at least one of a flexible material, a durable material, a washable material, and a stretchable material.

Further, in some embodiments, the at least one first magnetic element 104-106 may include at least one third magnetic element. Further, the at least one third magnetic element may be configured to be attachable to at least one of facial hair and head hair. Further, the at least one third magnetic element and the at least one first magnetic element 104-106 may be magnetically coupled. Further, the at least one first magnetic element 104-106 magnetically attaches to the at least one third magnetic element for attaching the at least one body portion 108-110 to at least one of the facial hair and the head hair.

FIG. 2 is a side perspective view of the face mask apparatus 100 with the at least one side strip 202-204, in accordance with some embodiments.

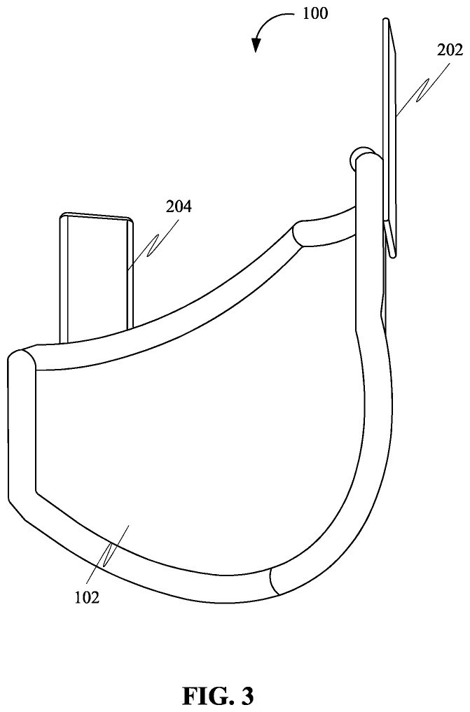

FIG. 3 is a rear perspective view of the face mask apparatus 100 with the at least one side strip 202-204, in accordance with some embodiments.

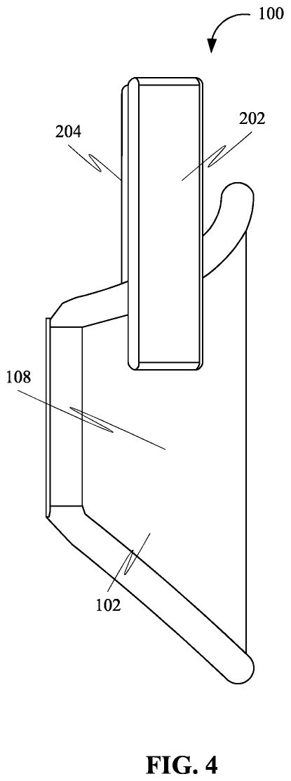

FIG. 4 is a side view of the face mask apparatus 100 with the at least one side strip 202-204, in accordance with some embodiments.

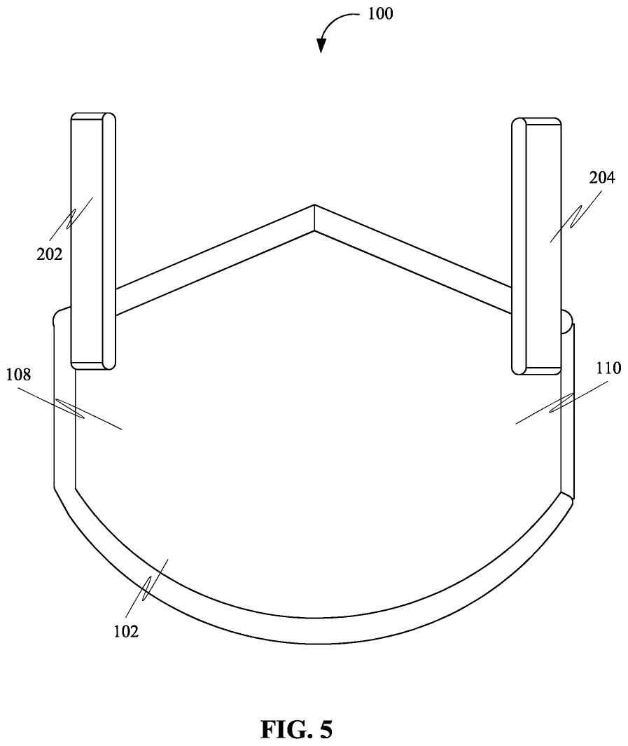

FIG. 5 is a front view of the face mask apparatus 100 with the at least one side strip 202-204, in accordance with some embodiments.

FIG. 6 is a front view of the face mask apparatus 100 with the at least one side strip 202-204, in accordance with some embodiments.

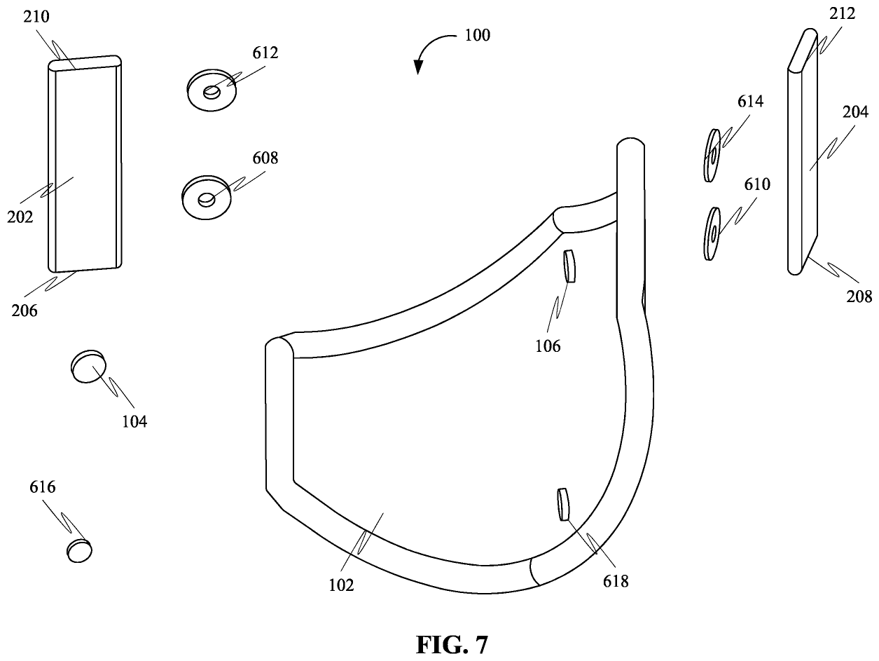

FIG. 7 is a disassembled view of the face mask apparatus 100 with the at least one side strip 202-204, in accordance with some embodiments.

FIG. 8 is a top perspective view of the at least one attachment device 800, in accordance with some embodiments.

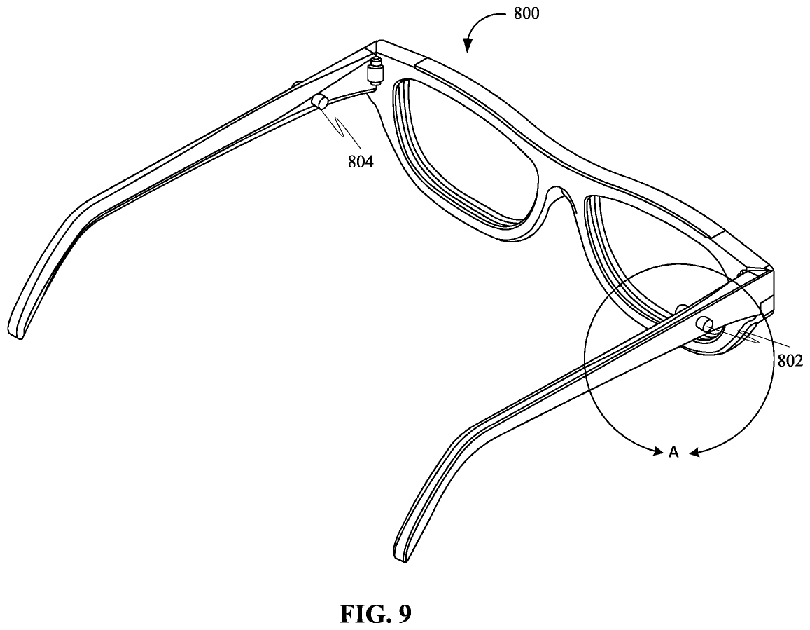

FIG. 9 is a rear perspective view of the at least one attachment device 800, in accordance with some embodiments.

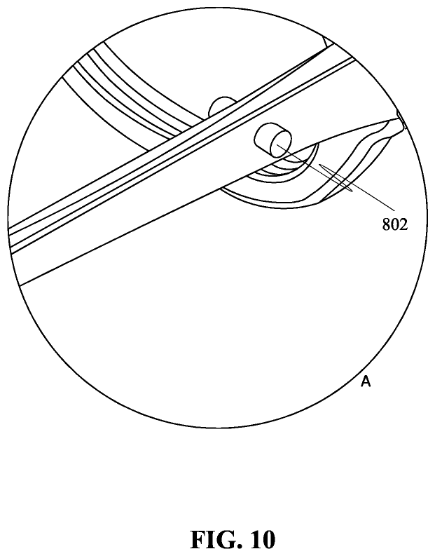

FIG. 10 is an enlarged view of a region A of FIG. 9, in accordance with some embodiments.

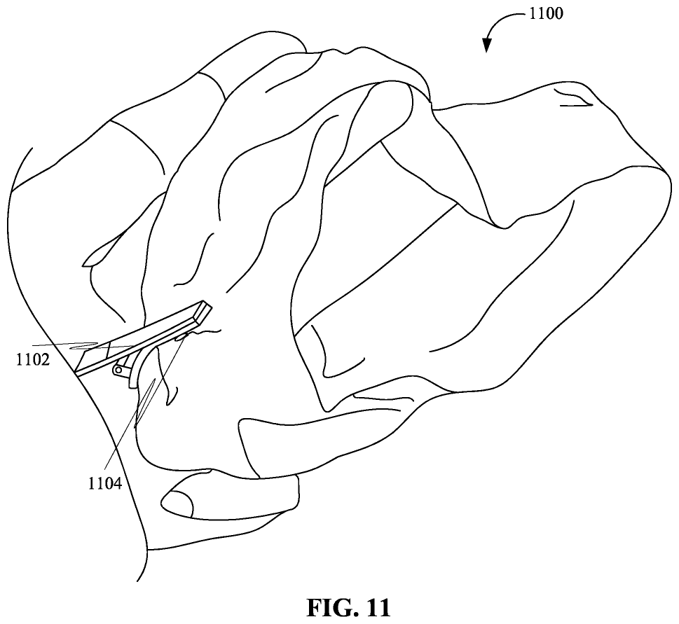

FIG. 11 is a perspective view of an attachment device 1100 of a face mask apparatus, in accordance with some embodiments. Further, the attachment device 1100 may include a metal clip 1102. Further, the metal clip 1102 may be used to attach a mask body of the face mask apparatus to a face of a user. Further, the metal clip 1102 may be attached to the attachment device 1100 using a magnet 1104 disposed in the attachment device 1100.

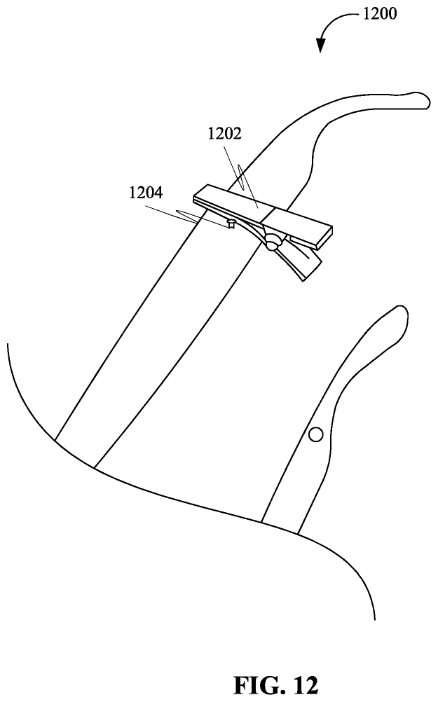

FIG. 12 is a partial perspective view of an attachment device 1200 of the face mask apparatus, in accordance with some embodiments. Further, the attachment device 1200 may include a metal clip 1202. Further, the metal clip 1202 may be used to attach a mask body of the face mask apparatus to a face of a user. Further, the metal clip 1202 may be attached to the attachment device 1200 using a magnet 1204 disposed in the attachment device 1200.

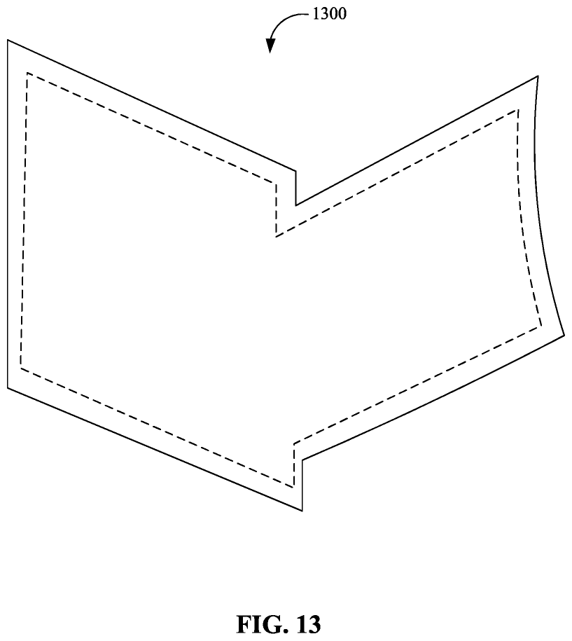

FIG. 13 is a front view of a mask body 1300 of the face mask apparatus, in accordance with some embodiments.

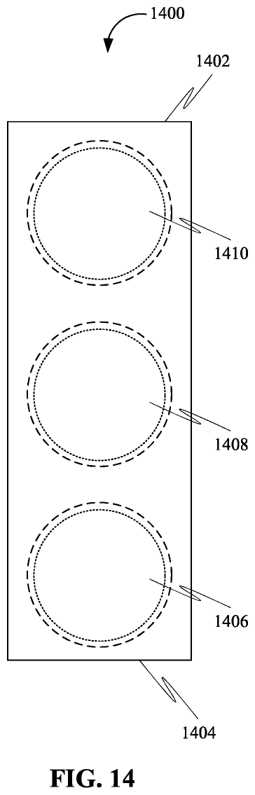

FIG. 14 is a front view of a side strip 1400 of the face mask apparatus, in accordance with some embodiments. Further, the side strip 1400 may extend between a first end 1402 and a second end 1404. Further, the side strip 1400 may include at least one magnetic element 1406-1410 disposed in the side strip 1400.

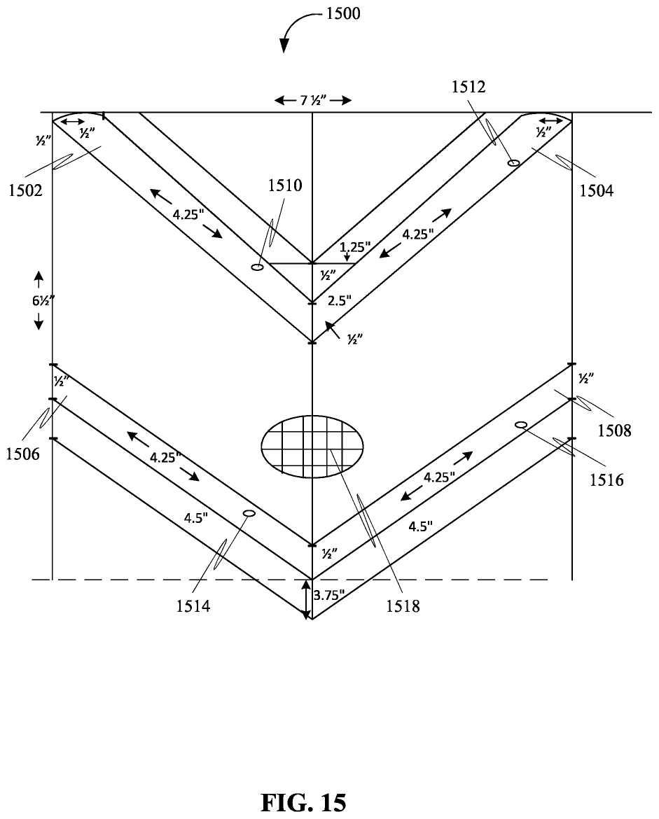

FIG. 15 is a front view of a mask body 1500 of a face mask apparatus, in accordance with some embodiments. Further, a width of the mask body 1500 is 7.5 inches. Further, a length of the mask body 1500 is 6.5 inches. Further, the mask body 1500 may include a plurality of tracks 1502-1508 formed on a plurality of edges of the mask body 1500. Further, the plurality of tracks 1502-1508 may be formed by folding and hemming the plurality of edges of the mask body 1500. Further, 0.5 inches of the mask body 1500 folded along the plurality of edges for forming the plurality of tracks 1502-1508. Further, a length of a track of the plurality of tracks 1502-1508 is 4.25 inches. Further, a plurality of magnets 1510-1518 may be disposed in the plurality of tracks 1502-1508. Further, the mask body 1500 may include a voice modulator 1518.

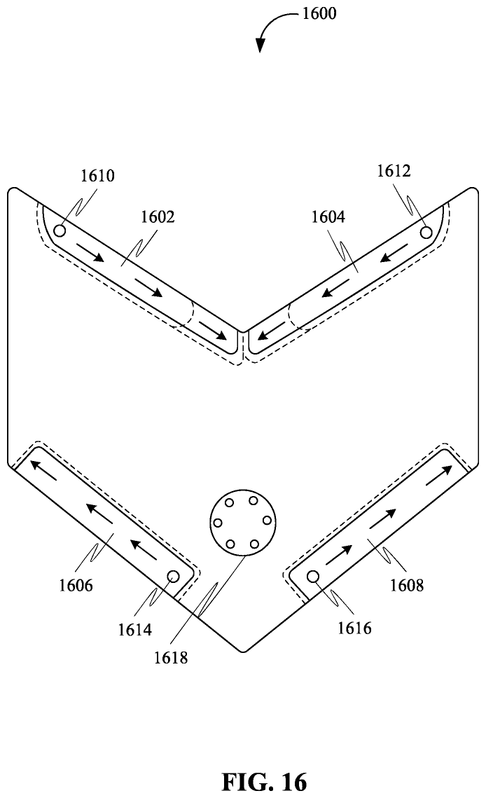

FIG. 16 is a front view of a mask body 1600 of a face mask apparatus, in accordance with some embodiments. Further, the mask body 1600 may include a plurality of tracks 1602-1608 formed on a plurality of edges of the mask body 1600. Further, a plurality of magnets 1610-1616 may be disposed in the plurality of tracks. Further, the mask body 1600 may include a voice modulator 1618.

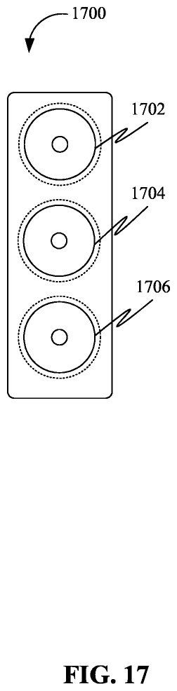

FIG. 17 is a front view of a side strip 1700 of the face mask apparatus, in accordance with some embodiments. Further, the side strip 1700 may include at least one magnetic material 1702-1706 stitched to the side strip 1700. Further, the at least one magnetic material 1702-1706 may include at least one washer. Further, the side strip 1700 may be comprised of at least one stretchable material.

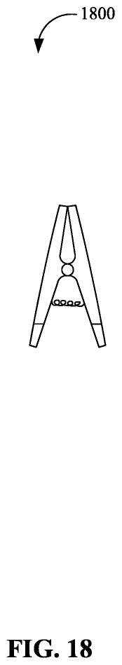

FIG. 18 is a front view of a metal clip 1800 of the face mask apparatus, in accordance with some embodiments. Further, the metal clip may include a flat stainless steel plate.

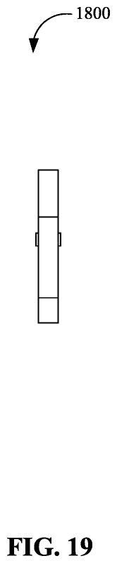

FIG. 19 is a side view of the metal clip 1800 of the face mask apparatus, in accordance with some embodiments.

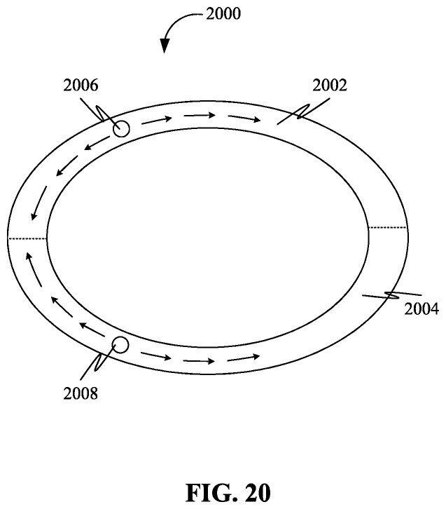

FIG. 20 is a top view of an attachment device 2000 of the face mask apparatus, in accordance with some embodiments. Further, the attachment device 2000 may include a headband. Further, the attachment device 2000 may include at least one cavity 2002-2004 and at least one magnet 2006-2008 movably disposed in the at least one cavity 2002-2004.

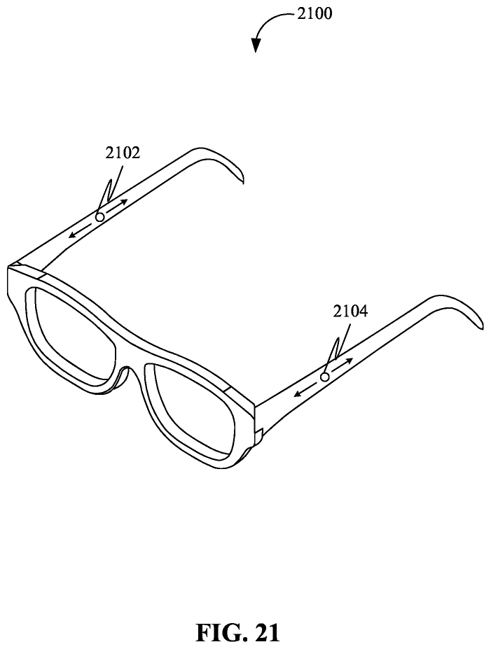

FIG. 21 is a top perspective view of an attachment device 2100 of the face mask apparatus, in accordance with some embodiments. Further, the attachment device 2100 may include a sunglass. Further, the attachment device 2100 may include at least one magnet 2102-2104 disposed in at least one portion of the attachment device 2100.

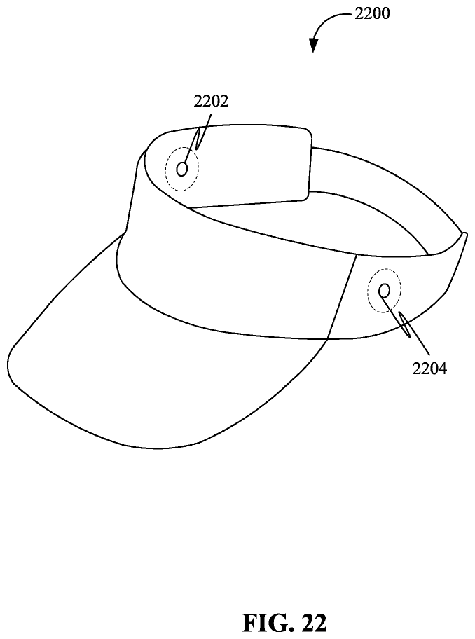

FIG. 22 is a top perspective view of an attachment device 2200 of the face mask apparatus, in accordance with some embodiments. Further, the attachment device 2200 may include a hat, a cap, etc. Further, the attachment device 2200 may include at least one magnet 2202-2204 disposed in at least one portion of the attachment device 2200.

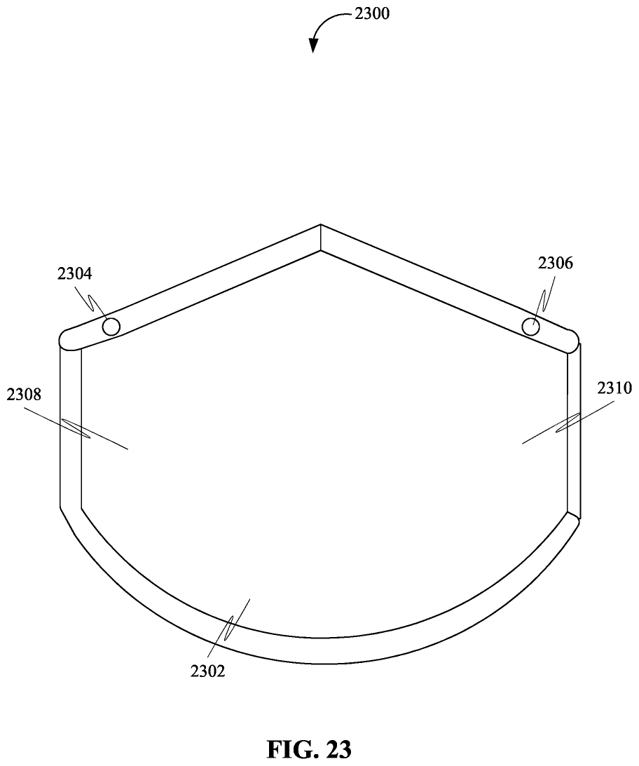

FIG. 23 is a front view of a face mask apparatus 2300, in accordance with some embodiments. Accordingly, the face mask apparatus 2300 may include a mask body 2302 and at least one first magnetic element 2304-2306.

Further, the at least one first magnetic element 2304-2306 may be disposed in at least one body portion 2308-2310 of the mask body 2302. Further, the at least one first magnetic element 2304-2306 may be magnetically couplable with at least one second magnetic element disposed in at least one device portion of at least one attachment device. Further, the at least one first magnetic element 2304-2306 magnetically attaches to the at least one second magnetic element for attaching the at least one body portion 2308-2310 to the at least one device portion. Further, the at least one attachment device may be worn on at least a part of a head of a user. Further, the at least one first magnetic element 2304-2306 and the at least one second magnetic element may be magnetically and detachably couplable. Further, the at least one first magnetic element 2304-2306 magnetically and detachably attaches to the at least one second magnetic element for detachably attaching the at least one body portion 2308-2310 to the at least one device portion.

Further, in some embodiments, the mask body 2302 may be configured for receiving at least one mask removing action on the mask body 2302. Further, the at least one first magnetic element 2304-2306 detaches from the at least one second magnetic element for detaching the at least one body portion 2308-2310 from the at least one device portion based on the receiving of the at least one mask removing action.

Further, in some embodiments, the mask body 2302 may include at least one upper track disposed on at least one upper edge body portion of the at least one body portion 2308-2310. Further, the at least one first magnetic element 2304-2306 may include at least one first upper magnetic element. Further, the at least one first upper magnetic element and the at least one second magnetic element may be magnetically couplable. Further, the at least one first upper magnetic element may be movably disposed in the at least one upper track. Further, the at least one second magnetic element may be fixedly disposed in the at least one device portion. Further, the at least one first upper magnetic element may be configured for moving to at least one upper location in the at least one upper track based on a placement of the mask body 2302 proximal to the at least one attachment device. Further, the at least one first upper magnetic element magnetically attaches to the at least one second magnetic element in the at least one upper location for the attaching of the at least one edge body portion to the at least one device portion based on the moving. Further, in an embodiment, the mask body 2302 may include at least one lower track disposed on at least one lower edge body portion of the at least one body portion 2308-2310. Further, the at least one first magnetic element 2304-2306 may include at least one first lower magnetic element. Further, the at least one first lower magnetic element and the at least one first upper magnetic element may be magnetically coupled. Further, the at least one first lower magnetic element may be movably disposed in the at least one lower track. Further, the at least one first lower magnetic element may be configured for moving to at least one lower location in the at least one lower track based on the moving of the at least one first upper magnetic element to the at least one upper location in the at least one upper track. Further, the moving of the at least one first lower magnetic element to the at least one lower location prevents folding of at least a body portion of the mask body 2302.

In further embodiments, at least one side strip may be configured for connecting the at least one attachment device and the mask body 2302. Further, the at least one side strip extends between a first end and a second end. Further, the at least one first magnetic element 2304-2306 may include at least one first strip magnetic element and at least one second strip magnetic element. Further, the at least one first strip magnetic element may be comprised in the first end and the at least one second strip magnetic element may be comprised in the second end. Further, the at least one first strip magnetic element and the at least one first magnetic element 2304-2306 may be magnetically couplable and the at least one second strip magnetic element and the at least one second magnetic element may be magnetically couplable. Further, the at least one first strip magnetic element magnetically attaches to the at least one first magnetic element 2304-2306 for attaching the first end with the at least one body portion 2308-2310 and the at least one second strip magnetic element magnetically attaches to the at least one second magnetic element for attaching the second end to the at least one device portion. Further, the connecting may be based on the attaching of the first end with the at least one body portion 2308-2310 and the attaching of the second end to the at least one device portion.

In further embodiments, at least one side strip may be configured for connecting the at least one attachment device and the mask body 2302. Further, the at least one side strip extends between a first end and a second end. Further, the first end may be attached to the at least one body portion 2308-2310. Further, the at least one first magnetic element 2304-2306 may include at least one strip magnetic element. Further, the at least one strip magnetic element may be comprised in the second end. Further, the at least one strip magnetic element and the at least one second magnetic element may be magnetically couplable. Further, the at least one strip magnetic element magnetically attaches with the at least one second magnetic element for attaching the second end to the at least one device portion. Further, the connecting may be based on the attaching of the second end to the at least one device portion.

In further embodiments, a voice modulator may be comprised in a mouth portion of the mask body 2302. Further, the voice modulator modulates a voice of the user.

Further, in some embodiments, the mask body 2302 may be comprised of at least one fabric. Further, the at least one fabric may be breathable. Further, in an embodiment, the at least one fabric may be comprised of at least one material. Further, the at least one material may include at least one of a flexible material, a durable material, a washable material, and a stretchable material.

Further, in some embodiments, the at least one first magnetic element 2304-2306 may include at least one third magnetic element. Further, the at least one third magnetic element may be configured to be attachable to at least one of facial hair and head hair. Further, the at least one third magnetic element and the at least one first magnetic element 2304-2306 may be magnetically coupled. Further, the at least one first magnetic element 2304-2306 magnetically attaches to the at least one third magnetic element for attaching the at least one body portion 2308-2310 to at least one of the facial hair and the head hair.

Although the present disclosure has been explained in relation to its preferred embodiment, it is to be understood that many other possible modifications and variations can be made without departing from the spirit and scope of the disclosure.

What is claimed is:

1. A face mask apparatus comprising:
a mask body; and
at least one first magnetic element disposed in at least one body portion of the mask body, wherein the at least one first magnetic element is magnetically couplable with at least one second magnetic element disposed in at least one device portion of at least one attachment device, wherein the at least one first magnetic element magnetically attaches to the at least one second magnetic element for attaching the at least one body portion to the at least one device portion, wherein the at least one attachment device is worn on at least a part of a head of a user.

2. The face mask apparatus of claim 1, wherein the at least one first magnetic element and the at least one second magnetic element are magnetically and detachably couplable, wherein the at least one first magnetic element magnetically and detachably attaches to the at least one second magnetic element for detachably attaching the at least one body portion to the at least one device portion.

3. The face mask apparatus of claim 2, wherein the mask body is configured for receiving at least one mask removing action on the mask body, wherein the at least one first magnetic element detaches from the at least one second magnetic element for detaching the at least one body portion from the at least one device portion based on the receiving of the at least one mask removing action.

4. The face mask apparatus of claim 1, wherein the mask body comprises at least one upper track disposed on at least one upper edge body portion of the at least one body portion, wherein the at least one first magnetic element comprises at least one first upper magnetic element, wherein the at least one first upper magnetic element and the at least one second magnetic element are magnetically couplable, wherein the at least one first upper magnetic element is movably disposed in the at least one upper track, wherein the at least one second magnetic element is fixedly disposed in the at least one device portion, wherein the at least one first upper magnetic element is configured for moving to at least one upper location in the at least one upper track based on a placement of the mask body proximal to the at least one attachment device, wherein the at least one first upper magnetic element magnetically attaches to the at least one second magnetic element in the at least one upper location for the attaching of the at least one edge body portion to the at least one device portion based on the moving.

5. The face mask apparatus of claim 4, wherein the mask body further comprises at least one lower track disposed on at least one lower edge body portion of the at least one body portion, wherein the at least one first magnetic element comprises at least one first lower magnetic element, wherein the at least one first lower magnetic element and the at least one first upper magnetic element are magnetically coupled, wherein the at least one first lower magnetic element is movably disposed in the at least one lower track, wherein the at least one first lower magnetic element is configured for moving to at least one lower location in the at least one lower track based on the moving of the at least one first upper magnetic element to the at least one upper location in the at least one upper track, wherein the moving of the at least one first lower magnetic element to the at least one lower location prevents folding of at least a body portion of the mask body.

6. The face mask apparatus of claim 1 further comprising at least one side strip configured for connecting the at least one attachment device and the mask body, wherein the at least one side strip extends between a first end and a second end, wherein the at least one first magnetic element comprises at least one first strip magnetic element and at least one second strip magnetic element, wherein the at least one first strip magnetic element is comprised in the first end and the at least one second strip magnetic element is comprised in the second end, wherein the at least one first strip magnetic element and the at least one first magnetic element are magnetically couplable and the at least one second strip magnetic element and the at least one second magnetic element are magnetically couplable, wherein the at least one first strip magnetic element magnetically attaches to the at least one first magnetic element for attaching the first end with the at least one body portion and the at least one second strip magnetic element magnetically attaches to the at least one second magnetic element for attaching the second end to the at least one device portion, wherein the connecting is based on the attaching of the first end with the at least one body portion and the attaching of the second end to the at least one device portion.

7. The face mask apparatus of claim 1 further comprising at least one side strip configured for connecting the at least one attachment device and the mask body, wherein the at least one side strip extends between a first end and a second end, wherein the first end is attached to the at least one body portion, wherein the at least one first magnetic element comprises at least one strip magnetic element, wherein the at least one strip magnetic element is comprised in the second end, wherein the at least one strip magnetic element and the at least one second magnetic element are magnetically couplable, wherein the at least one strip magnetic element magnetically attaches with the at least one second magnetic element for attaching the second end to the at least one device portion, wherein the connecting is based on the attaching of the second end to the at least one device portion.

8. The face mask apparatus of claim 1 further comprising a voice modulator comprised in a mouth portion of the mask body, wherein the voice modulator modulates a voice of the user.

9. The face mask apparatus of claim 1, wherein the mask body is comprised of at least one fabric, wherein the at least one fabric is breathable.

10. The face mask apparatus of claim 9, wherein the at least one fabric is comprised of at least one material, wherein the at least one material comprises at least one of a flexible material, a durable material, a washable material, and a stretchable material.

11. The face mask apparatus of claim 1, wherein the at least one first magnetic element comprises at least one third magnetic element, wherein the at least one third magnetic element is configured to be attachable to at least one of facial hair and head hair, wherein the at least one third magnetic element and the at least one first magnetic element are magnetically coupled, wherein the at least one first magnetic element magnetically attaches to the at least one third magnetic element for attaching the at least one body portion to at least one of the facial hair and the head hair.

12. A face mask apparatus comprising:
a mask body; and
at least one first magnetic element disposed in at least one body portion of the mask body, wherein the at least one first magnetic element is magnetically couplable with at least one second magnetic element disposed in at least one device portion of at least one attachment device, wherein the at least one first magnetic element magnetically attaches to the at least one second magnetic element for attaching the at least one body portion to the at least one device portion, wherein the at least one attachment device is worn on at least a part of a head of a user, wherein the at least one first magnetic element and the at least one second magnetic element are magnetically and detachably couplable, wherein the at least one first magnetic element magnetically and detachably attaches to the at least one second magnetic element for detachably attaching the at least one body portion to the at least one device portion.

13. The face mask apparatus of claim 12, wherein the mask body is configured for receiving at least one mask removing action on the mask body, wherein the at least one first magnetic element detaches from the at least one second magnetic element for detaching the at least one body portion from the at least one device portion based on the receiving of the at least one mask removing action.

14. The face mask apparatus of claim 12, wherein the mask body comprises at least one upper track disposed on at least one upper edge body portion of the at least one body portion, wherein the at least one first magnetic element comprises at least one first upper magnetic element, wherein the at least one first upper magnetic element and the at least one second magnetic element are magnetically couplable, wherein the at least one first upper magnetic element is movably disposed in the at least one upper track, wherein the at least one second magnetic element is fixedly disposed in the at least one device portion, wherein the at least one first upper magnetic element is configured for moving to at least one upper location in the at least one upper track based on a placement of the mask body proximal to the at least one attachment device, wherein the at least one first upper magnetic element magnetically attaches to the at least one second magnetic element in the at least one upper location for the attaching of the at least one edge body portion to the at least one device portion based on the moving.

15. The face mask apparatus of claim 14, wherein the mask body further comprises at least one lower track disposed on at least one lower edge body portion of the at least one body portion, wherein the at least one first magnetic element comprises at least one first lower magnetic element, wherein the at least one first lower magnetic element and the at least one first upper magnetic element are magnetically coupled, wherein the at least one first lower magnetic element is movably disposed in the at least one lower track, wherein the at least one first lower magnetic element is configured for moving to at least one lower location in the at least one lower track based on the moving of the at least one first upper magnetic element to the at least one upper location in the at least one upper track, wherein the moving of the at least one first lower magnetic element to the at least one lower location prevents folding of at least a body portion of the mask body.

16. The face mask apparatus of claim 12 further comprising at least one side strip configured for connecting the at least one attachment device and the mask body, wherein the at least one side strip extends between a first end and a second end, wherein the at least one first magnetic element comprises at least one first strip magnetic element and at least one second strip magnetic element, wherein the at least one first strip magnetic element is comprised in the first end and the at least one second strip magnetic element is comprised in the second end, wherein the at least one first strip magnetic element and the at least one first magnetic element are magnetically couplable and the at least one second strip magnetic element and the at least one second magnetic element are magnetically couplable, wherein the at least one first strip magnetic element magnetically attaches to the at least one first magnetic element for attaching the first end with the at least one body portion and the at least one second strip magnetic element magnetically attaches to the at least one second magnetic element for attaching the second end to the at least one device portion, wherein the connecting is based on the attaching of the first end with the at least one body portion and the attaching of the second end to the at least one device portion.

17. The face mask apparatus of claim 12 further comprising at least one side strip configured for connecting the at least one attachment device and the mask body, wherein the at least one side strip extends between a first end and a second end, wherein the first end is attached to the at least one body portion, wherein the at least one first magnetic element comprises at least one strip magnetic element, wherein the at least one strip magnetic element is comprised in the second end, wherein the at least one strip magnetic element and the at least one second magnetic element are magnetically couplable, wherein the at least one strip magnetic element magnetically attaches with the at least one second magnetic element for attaching the second end to the at least one device portion, wherein the connecting is based on the attaching of the second end to the at least one device portion.

18. The face mask apparatus of claim 12 further comprising a voice modulator comprised in a mouth portion of the mask body, wherein the voice modulator modulates a voice of the user.

19. The face mask apparatus of claim 12, wherein the mask body is comprised of at least one fabric, wherein the at least one fabric is breathable.

20. The face mask apparatus of claim 12, wherein the at least one first magnetic element comprises at least one third magnetic element, wherein the at least one third magnetic element is configured to be attachable to at least one of facial hair and head hair, wherein the at least one third magnetic element and the at least one first magnetic element are magnetically coupled, wherein the at least one first magnetic element magnetically attaches to the at least one third magnetic element for attaching the at least one body portion to at least one of the facial hair and the head hair.
